(19) United States
(12) Patent Application Publication
(10) Pub. No.: US 2016/0178171 A1
(43) Pub. Date: Jun. 23, 2016

(54) LIGHTS ON A TRACK WITH BRAKING FEATURE

(71) Applicant: 3M INNOVATIVE PROPERTIES COMPANY, Saint Paul, MN (US)

(72) Inventor: Thomas J. Reid, White Bear Lake, MN (US)

(21) Appl. No.: 14/910,125

(22) PCT Filed: Aug. 20, 2014
(86) PCT No.: PCT/US2014/051798

§ 371 Date: Feb. 4, 2016

Related U.S. Application Data
(60) Provisional application No. 61/868,148, filed on Aug. 21, 2013.

(51) Int. Cl. F21V 21/34; F21S 8/06

(52) U.S. Cl. CPC F21V 21/34; F21S 8/066; F21W 2131/402

(57) ABSTRACT

Described is an overhead lighting device (10) that slides on a track (12) that may be continuous and has a releasable brake (20). A light bar (14) comprising a plurality of light sources (16) is in movable contact with the track (12). The releasable brake (20) has a first position that locks the light bar (14) in place and a second position that allows the light bar (14) to move freely. The light bar (14) may move from a position parallel to the track (12) to a hinged position that allows a user to position the light bar (14) as much as perpendicular to the track. Members (32) to mount the device (10) are flexible to facilitate packaging and shipping of the device (10), where the members (32) are sleeved (34) with a material that can be made rigid upon installation by, for example, the use of resin-impregnated materials such as knit fiberglass, foam, or cloth or the use of thermoset plastics.

### TECHNICAL FIELD

This disclosure relates generally to lights and light fixtures. More specifically, the invention relates to an overhead lighting device that slides on a track that may be continuous and has a releasable brake.

### BACKGROUND

Auto body shops and garages are often poorly lit. This poses a problem when a vehicle is painted in conjunction with a repair. The repair painting process includes pre-painting inspection to determine scope of service or repair, painting itself, immediate post-painting inspection prior to finishing, finishing, and post-repair inspection prior to customer pick-up. During each of these steps, poor lighting may mean that defects go undetected when they can be fixed most expediently and efficiently, resulting wasted time and effort and an overall unsatisfactory paint job. Furthermore, floors of stalls of auto body shops and garages tend to collect a great deal of tools and equipment such that there is not much available floor space for lighting.

Thus, there is a need for a light fixture that illuminates well a significant portion of a vehicle during the paint finishing process and enables a technician to detect or observe defects, but that also does not take up a lot of floor space in the garage.

### SUMMARY

Achieving adequate work lighting in auto body garages poses a challenge due to space constraints, high-ceilings, and dirty, dark, and unreflective floors of the garages. A solution to this challenge is to provide a track with a light bar where the track provides a path that permits many options of locating the light bar around the perimeter of the vehicle and where the light bar is movable to different heights and/or angles. Under many circumstances, it is desirable that the track is continuous and the light bar has a braking feature that is easily operated.

In a first aspect, provided is a lighting device comprising: a track; a light bar comprising a plurality of light sources in movable contact with the track; and a releasable brake in communication with both the track and the light bar, the releasable brake having a first position that locks the light bar in place and a second position that allows the light bar to move freely.

Other features that may be used individually or in combination are as follows. The lighting device may further comprise a power cord operatively connected to the light bar. The track may continuous. The releasable brake may be operatively connected to an end of the light bar and a mobile mechanism. In a detailed embodiment, the releasable brake comprises a spring plunger. The plunger may optionally have an added feature such as a rubber tip to increase friction during braking. Further, a pull cord may be attached to the spring plunger for engaging the releasable brake. Optionally, at least one light source may be detachable from the light bar. The lighting device may further comprise a fastener located on one end of the light bar, wherein in a first position, the light bar is substantially parallel to the track and in a second position, the light bar is angled or not parallel to the track. One end of the light bar may be attached to the track by a hinge. Upon installation, the track may be suspended from a ceiling by a mounting member. The mounting member may be a chain, wire cable, rope, or combinations thereof, which may optionally be sheathed in a sleeve. In addition, any portion of the device may be provided with softened edges or surfaces, i.e., foam or rubber trim, in order to avoid causing damage to a vehicle should the device inadvertently come into contact with the vehicle during use.

In detailed embodiments, the light sources may independently be selected from incandescent lamps/bulbs, electroluminescent lamps/bulbs, fluorescent lamps/bulbs, gas discharge lamps/bulbs, halogen lamps/bulbs, LED lamps/bulbs, and combinations thereof. In one embodiment, the light sources comprise incandescent lamps. In another embodiment, the light sources comprise LED lamps. A further embodiment provides that the light sources comprise halogen bulbs in combination with a power regulator.

A detailed aspect provides that the lighting devices disclosed herein are hung by flexible mounting members that comprise a sleeve over the flexible members to impart rigidity. The sleeve may comprise a fiberglass mesh fabric, a foam, another form of cloth, or a thermoset plastic. The sleeve may be impregnated as needed with a resin or other material that is capable of imparting rigidity.

Another aspect provides methods of installing a light device, the methods comprising: obtaining any lighting device disclosed herein, for example, one comprising a track and a light bar and/or a light source; associating and/or affixing one or more mounting members comprising a sleeve to the track and a mounting structure; and imparting rigidity to the sleeve. The one or more mounting members may comprise chain, wire cable, rope, or combinations thereof and the sleeve may comprises a fiberglass mesh, a foam, a cloth, or a thermoset plastic. The sleeve may be impregnated with a resin as needed to be effective to provide rigidity to the one or more mounting members. When the sleeve comprises the fiberglass mesh fabric, the foam, or the cloth, impregnated resin may be water-curable, UV or visible light curable, or two-part. In a detailed embodiment, the fiberglass mesh fabric is impregnated with a water-activated resin, and the step to impart rigidity comprises exposing the sleeve to water. When the sleeve comprises the thermoset plastic it may become rigid upon application of heat.

Other aspects include kits for illuminating a vehicle, the kit comprising; any lighting device disclosed herein, for example, a lighting device comprising a track, a light bar, and a releasable brake; at least one mounting member; and a sleeve for the mounting member. In one embodiment, the sleeve comprises a knitted fiberglass fabric impregnated with a water-activated polyurethane resin that is curable.

These and other aspects of the invention are described in the detailed description below. In no event should the above summary be construed as a limitation on the claimed subject matter.

### BRIEF DESCRIPTION OF THE DRAWINGS

The accompanying drawings are included to provide a further understanding of the invention described herein and are incorporated in and constitute a part of this specification. The drawings illustrate exemplary embodiments. Certain features may be better understood by reference to the following detailed description when considered in connection with the accompanying drawings, in which like reference numerals designate like parts throughout the figures thereof, and wherein:

FIG. 1 is a schematic of a lighting device according to one or more embodiments;

FIG. 2 is an enlarged schematic view of one end of a lighting device according to one or more embodiments;

FIG. 3 is an enlarged schematic view of a fastener of a lighting device according to one or more embodiments;

FIG. 4A is a schematic view of another end of a lighting device according to one or more embodiments; FIG. 4B is a close-up of one embodiment of a hinge; and

FIG. 5 is a schematic view of a mounting member according to one or more embodiments.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

Provided is a lighting device with an arrayed light source that is large enough to visualize an area as large as a door or hood or an entire vehicle to be inspected and assessed at once, but that does not take up any floor space in a room or garage or stall. Such lighting devices may use light sources such as 3M™ PPS™ Sun Gun™ color corrective bulbs that are discussed in detail herein, which simulates natural light within the body shop or garage. The lighting devices disclosed herein are useful during many steps of vehicle repair painting processes, including pre-painting inspection to determine scope of service or repair, immediate post-painting inspection prior to finishing, finishing, and post-repair inspection prior to customer pick-up.

With respect to pre-painting inspection, as the vehicle is brought over from the body repair area of the shop, it is useful to inspect the entire vehicle before repair painting occurs. There may be issues from the body repair that go undetected until, unfortunately, right after painting that would have been far easier/less time consuming to fix before painting. The main issues are: sand scratches from body repair (straightening and filling panel with body filler) and pin holes in body filler. Moreover, there is a need for a general inspection of the body repair area to be sure things are in proper condition before painting.

Right after painting, the lighting devices may be used while checking blending of the paint to see if the blend worked acceptably (before beginning paint finishing). Blending accounts for the fact that nearly all repair paint differs no matter how slightly from the color and/or hue of the original paint. Painters typically use adjacent body panels to “blend” the paint out to adjacent panels/locations of the vehicle so it appears to match visually. In some instances, if the blend is poor, the painters may have to spray the whole side of a vehicle so that the repair is not perceived. The lighting devices are very helpful as they illuminate a significant portion of the vehicle (repair area and blend area combined into a larger view of vehicle). The use of 3M™ PPS™ Sun Gun™ color corrective bulbs, for example, shows correctness of the blend very easily.

Paint finishing involves the removal of dust nibs and other particles, paint runs, and other defects from fresh paint coated on a vehicle. Because of the lack of light, it is very difficult, sometimes impossible, to see swirls and dieback that may occur during paint finishing. Dieback in this context is a dulling of a finish due to reappearance of sanding scratches that were temporarily filled with oils from rubbing or polishing compounds. The lighting devices are very helpful to detect swirls and dieback.

The lighting devices may also be used as general inspection lights at the end of repair to be sure that the vehicle is correct and ready for delivery to customer. The customer usually picks up the vehicle outdoors, so being able to check the vehicle while it is still indoors (with “daylight” 3M™ PPS™ Sun Gun™ color corrective bulbs that show vehicle similar to the way the customer will see it outdoors) has value. That is, if the vehicle looks right under the lights, there will be no surprises later with the customer.

With respect to terms used in this disclosure, the following definitions are provided.

As used herein, the use of “a,” “an,” and “the” includes the singular and plural.

As used herein, the term “track” refers to a pathway or conduit, made of a metal, plastic, or other material, to which light bars and/or one or more individual light sources are attached. A track may be suspended from a ceiling, such as, for example, the ceiling of an auto body garage or shop, or a track may be mounted to a wall or other surface. A track may be any shape as needed for a particular application, such as, for example, circular, semi-circular, rectangular, etc. A track that is “continuous” is one that has no ends or discontinuity in its path. A track may be open in that an “I-beam” is used, or it may be closed such that caster wheels roll inside an enclosed track with open bottom in center to allow hanging of light bar.

As used herein, the term “light bar” refers to a bar, made of a metal, plastic, or other material, that houses a plurality of light sources. Light bars may contain fixed, rotating, or strobe light sources in various configurations. Light bars contain electrical conductors, such that the routing of electrical wiring to individual light positions is not required. Light bars may be mounted directly to ceilings or walls, lengthwise down beams, crosswise across rafters or joists, and/or along a track. Typically, light bars have line voltage running through them in a recess, and may have more than one live conductor so that multiple switched circuits can be used to control different fittings on the same light bar.

As used herein, the term “light source” refers to electric or battery powered lights, including, but not limited to, incandescent lamps and bulbs, electroluminescent lamps and bulbs, fluorescent lamps and bulbs, gas discharge lamps, halogen lamps and bulbs, and LED lamps and bulbs. Light sources may include 3M™ PPS™ Sun Gun™ color corrective bulbs, which are color matching lights that provide a consistent beam of light having a virtually identical balance to the color spectrum of natural light, using, for example, halogen bulbs in combination with an internal power regulator.

As used herein, the term “power cord” refers to a cable that connects a piece of equipment to an electricity supply, a battery, or other power supply. A power cord may be either fixed or detachable from the piece of equipment.

As used herein, the term “releasable brake” refers to a brake that provides an engaged or locked position with respect to a structure, and upon release, the structure is freely moveable. For the purposes of this disclosure, a releasable brake differs from a continuous friction brake, which imparts friction at all times to a surface, which restricts motion and inhibits a structure from moving freely. An exemplary releasable brake is a hand-retractable plunger that uses a spring to move the components of the brake from an engaged or locked position to a released position. The releasable brake permits the structure to be positioned at any location on the surface before the engaged or locked position is chosen. A releasable brake differs from a simple stop, where a simple stop is placed in a location directly in a path or track of an item that is being moved such that the location of the stop is fixed and the stop serves as a barrier to the movement of the item at that location.

As used herein, the term “spring plunger” refers to a device commonly available for applications as positioners, locating pins, and indexing devices. A spring plunger typically comprises a threaded body and may have a hex head or used threaded nuts for ease of fastening the threaded body in an opening. A spring resides on the body and is installed in an expanded position to push a plunger against a surface to provide a locked position. Compression of the spring releases the plunger from the surface to provide an unlocked position. Suitable hand retractable/releasable spring plungers are available commercially from sources including McMaster-Carr. The plunger may optionally have an added feature such as a rubber tip to increase friction during braking

As used herein, the term “pull cord” refers to a flexible member extending from a mechanism, the flexible member may include, but is not limited to: a string, cord, or chain-wound around a spring-loaded spindle that engages or operates a mechanism when it is pulled.

As used herein, the term “push button” refers to a button or switch mechanism for controlling some aspect of a machine or process. A push button is typically made out of a hard material, for example, plastic or metal. The surface of a push button is usually flat or shaped to accommodate the human finger or hand, so as to be easily depressed or pushed.

As used herein, the term “hinge” refers to a type of bearing that connects two solid objects, typically allowing only a limited angle of rotation between them. Two objects connected by a hinge rotate relative to each other about a fixed axis of rotation. Hinges may be made of flexible material or of moving components. Hinges may be spring-loaded and adjustable to provide tension/resistance as needed. Hinges may also be adjusted or formed to deliver a limited angle of motion as desired.

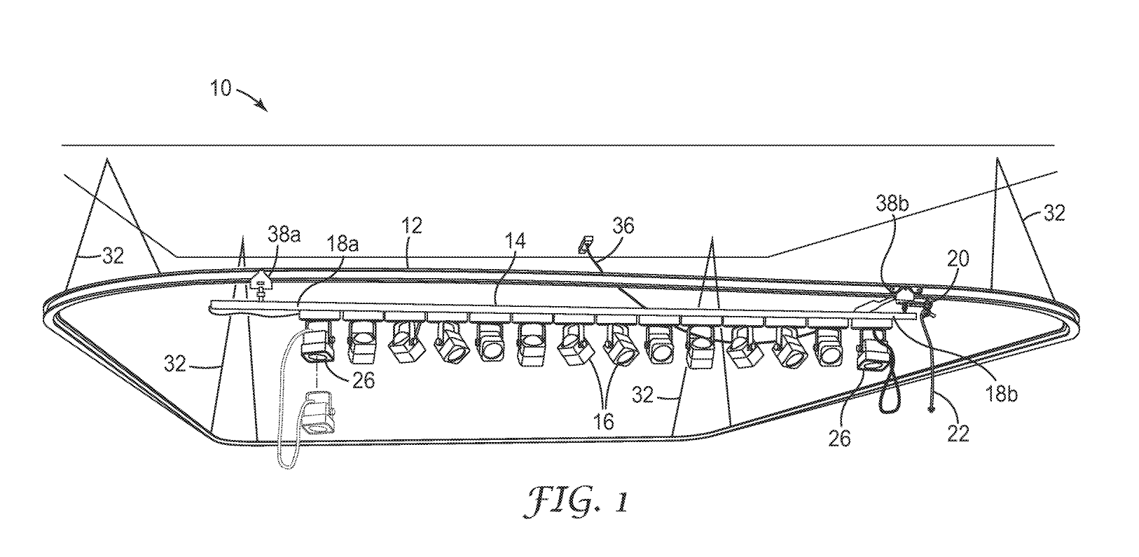

FIGS. 1 through 5 illustrate a lighting device according to one or more embodiments of the present invention. Referring to FIG. 1, in one or more embodiments, the lighting device 10 comprises a track 12, a light bar 14, and a releasable brake 20. The track 12 in this embodiment is continuous, providing many options for locating the device in the work space. In one or more embodiments, the light bar 14 has a length and two ends 18a and 18b, and comprises a plurality of light sources 16. The releasable brake 20 has a first position that locks the light bar 14 in place and a second position that allows the light bar 14 to move freely about the track 12.

In one or more embodiments, the lighting device 10 further comprises a power cord 36. The power cord may be fixed or integral to the lighting device 10, or the power cord may be detachable. The power cord connects the lighting device 10 to an electricity supply, to a battery, or to another power supply.

According to one or more embodiments, the track 12 may be suspended from a ceiling or from a mounting structure associated with the ceiling, such as, for example, the ceiling of an auto body garage, where the lighting device can be used to illuminate a significant portion of a vehicle. Such mounting structures may be ceiling girders, beams, or ceiling framework that is present. Alternatively, heavy duty toggle bolts screwed into sheet rock ceilings may be used. In addition, other flat ceiling panels may be used if they are secured well enough to the internal structure of the ceiling. In one or more embodiments, the track provides a pathway upon which the light bar may slide freely such that the light bar may be moved about the perimeter of a vehicle to illuminate portions of the vehicle as needed. The track 12 is lightweight and is easily hung with one or more mounting members 32 such as small chain, wire cable, rope, or combinations thereof. Because the lighting device can be suspended from a ceiling or a mounting structure associated with he ceiling, this relieves a need to use floor space of an auto body garage or stall. The track 12 may be of any shape, such as, for example, circular, semi-circular, rectangular, etc. In one or more embodiments, the track 12 forms a 360° circle or other continuous shape. Generally, the track is wider and longer than the vehicles being worked on. An exemplary track 12 may be up to about 20 feet long by about 15 feet wide, with curved corners. According to a specific embodiment, the track 12 measures about 16 feet long by about 12 feet wide, with a radius of about 2 feet curved in the corners.

According to one or more embodiments, the light bar 14 slides along the track 12 on mobile mechanisms 38a, 38b using pull cord 22, which doubles as a way to release brake 20. The mobile mechanisms may be the same or different. In the embodiment of FIG. 1, mobile mechanism 38b has four wheels (two on each side of I-beam track), whereas mobile mechanism 38a has two (one on each side of I-beam track, not shown). Mobile mechanisms are not limited to having wheels to provide mobility. Mobile mechanisms may have plastic or other material that is smooth and facilitates movement of the light bar. When the track 12 is suspended from the ceiling, the light bar 14 in a first position may be parallel to the track and the ceiling. The light bar 14 may have a length of up to 6 feet long and has two ends 18a and 18b. In one or more embodiments, the light bar 14 comprises a plurality of light sources 16. While the number of light sources is determined based on application and available space and tailored to any desired number, in specific embodiments, the light bar 14 may comprise up to 15 light sources, including 1, 2, 3, 4, 5, 6, 7, 8, 9, 10, 11, 12, 13, 14, and 15 light sources. The light sources may include, but are not limited to, incandescent lamps and bulbs, electroluminescent lamps and bulbs, fluorescent lamps and bulbs, gas discharge lamps and bulbs, halogen lamps and bulbs, LED lamps and bulbs, and combinations thereof. In specific embodiments, the light sources 16 comprise incandescent lamps. In other embodiments, the lights sources 16 comprise LED lamps. In specific embodiments, the light sources comprise 3M™ PPS™ Sun Gun™ color corrective bulbs. In one or more embodiments, the light sources 16 are not fixed in place and may be rotated and/or pivoted and/or moved along the length of the light bar 14.

Detachable light sources are optionally included with the lighting devices. For example, at least one detachable light source 26 may be detachable from the light bar 14 and may be located at one or both ends 18a, 18b. In one or more embodiments, two detachable light sources 26 located on various locations along the light bar, and in a specific embodiment, each light source 16 of the light bar 14 is detachable. In one or more embodiments, the detachable light source 26 is an inspection light, which allows very close inspection of the vehicle as needed. For example, the detachable light source 26 can be used by a technician to closely inspect the paint of a vehicle for any flaws or dieback. In one or more embodiments, the detachable light sources 26 may include, but are not limited to, incandescent lamps and bulbs, electroluminescent lamps and bulbs, fluorescent lamps and bulbs, gas discharge lamps, halogen lamps and bulbs, LED lamps and bulbs, and combinations thereof. In some embodiments, the detachable light sources 26 comprise incandescent lamps. In other embodiments, the detachable light sources 26 comprise LED lamps. In specific embodiments, the detachable light sources 26 comprise 3M™ PPS™ Sun Gun™ color corrective bulbs.

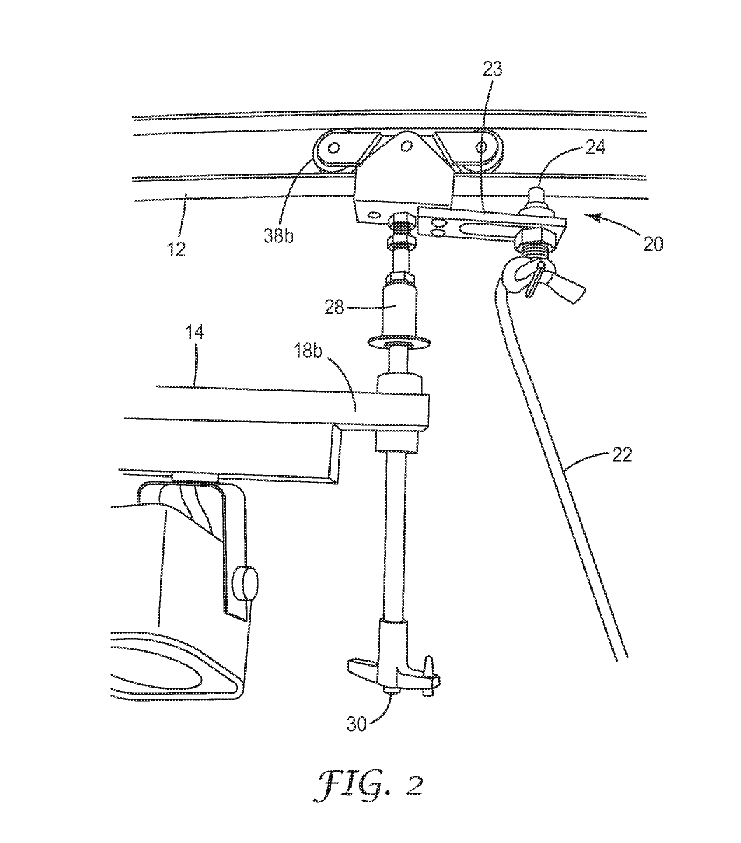

Referring to FIG. 2, providing a close-up of a brake-end of the lighting device, according to one or more embodiments, the releasable brake 20 is operatively associated with one end 18b of the light bar 14. In one or more embodiments, the releasable brake 20 comprises a spring plunger 24 that releases from the track 12 by pulling on pull cord 22, so that the light bar 14 can move about the track 12 freely on mobile mechanisms 38b and 38a (not shown). In one or more embodiments, the spring plunger 24 has a first position that locks the light bar 14 in place on the track 12, and a second position that allows the light bar 14 to move freely along the track 12. The releasable brake 20 differs from a continuous friction brake, which is constantly engaged during movement. A continuous friction brake creates too much friction when trying to move freely a large light bar assembly along a track. Thus, a releasable brake 20 is used to eliminate any friction and permit the light bar 14 to be moved freely about the perimeter of the track 12. When a technician pulls the pull cord 22, the spring plunger 24 releases from a surface of the track 12, allowing the light bar 14 to freely slide about the track 12 to where light is needed for the technician's work. When the technician releases the pull cord 22, the spring plunger 24 contacts the surface of the track 12, locking the light bar 14 in place along the track 12. In one or more embodiments, the pull cord 22 has a second function of allowing the technician to slide the light bar 14 freely along the track 12 so that the lighting device can illuminate various portions of a vehicle as needed.

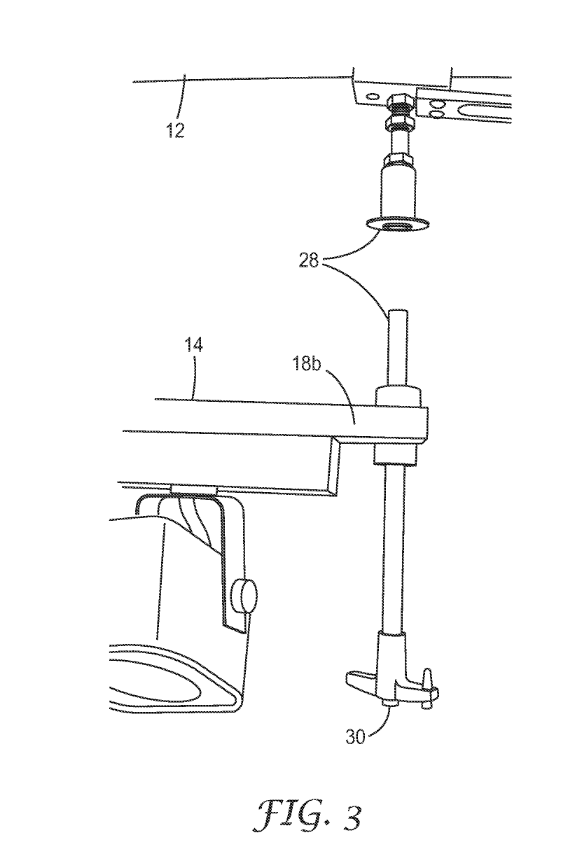

The releasable brake 20 may have a bracket 23 to affix it to mobile mechanism 38b and mobile mechanism 38b may be affixed to the light bar 14 by a fastener 28 such as a quick-release pin. A quick-release pin may have a rod with a protruding spring-loaded bearing towards one end that engages with a locking groove in a receiving piece or caster. A push button 30 on another end of the rod is used to release the protruding spring and to allow the rod to disengage from the receiving piece or caster. In FIG. 3, the released position of fastener 28 is shown. In one or more embodiments, the push button 30 is made out of a hard material, for example, plastic or metal, and the surface of the push button 30 is flat or shaped to accommodate the human finger or hand, so as to be easily depressed or pushed by the technician. In one or more embodiments, when the technician pushes the push button 30, the light bar 14 is released at one end 18b from the track 12 and swings down such that the light bar 14 is no longer substantially parallel to the track or ceiling and is angled or even perpendicular to the track or ceiling.

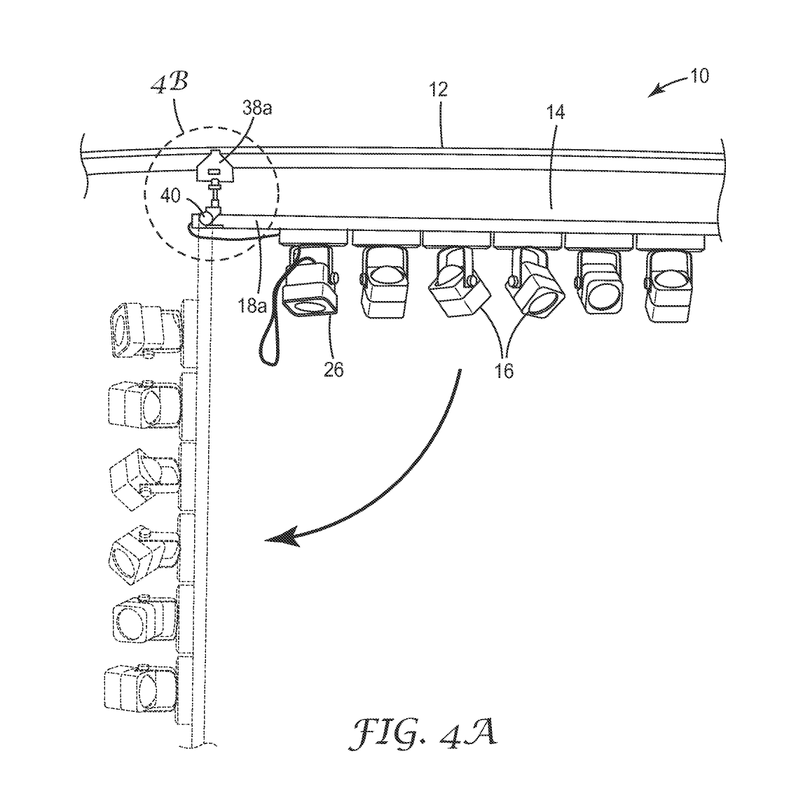

Referring to FIG. 4A, according to one or more embodiments, the lighting device 10 is hinged on one end 18a of the light bar 14 comprising the plurality of light sources 16 and optionally a detachable light 26. Accordingly, in one or more embodiments, the lighting device 10 further comprises a hinge 40. When the technician releases fastener 28 as shown in FIG. 3, the track 12 at one end 18b swings down such that the light bar 14 is now angled or no longer parallel, for example, perpendicular, or any angle in between, to the ceiling. This allows for illumination of lower sides of the vehicle. The hinge 40 may be spring-loaded and adjustable to provide tension/resistance as needed. That is, there may be increasing tension/resistance as the hinge is opened more completely. This is to counterbalance to some extent the weight of the light assembly as it swings down. The tension/resistance may be adjusted according to a technician's needs. FIG. 4B provides a close-up of the hinge 40 in an open position.

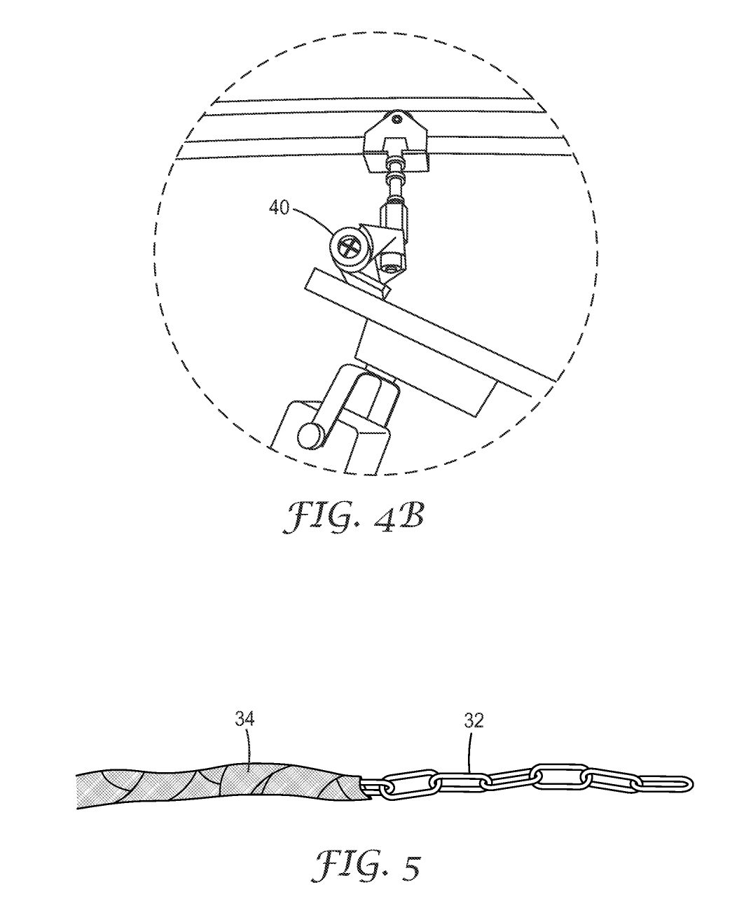

Referring to FIG. 5, according to one or more embodiments, the track, not pictured, is suspended from the ceiling or a mounting structure affixed to the ceiling through the use of one or more mounting members 32 such as chain, rope, wire cable, or combinations thereof. Flexible mounting members may be used to facilitate shipping and installation. Typically, the mounting members would be looped over mounting structures, for example structural supports such as girders, beams, or ceiling framework as available and/or already-existing in the garage or location of installation. Suspension of the track from the ceiling or mounting structure using flexible mounting member 32 may result in some sway of the lighting device. In one or more embodiments, the mounting members 32 are sheathed in a sleeve 34 that is capable of becoming rigid in order to minimize sway of the lighting device. The sleeve 34 may comprise a fiberglass mesh fabric, a foam, another form of cloth, or a thermoset plastic. The sleeve may be impregnated with a resin or other material that is capable of imparting rigidity or it may be thermally sensitive such that upon application of heat it becomes rigid. In specific embodiments, the sleeve 34 comprises Scotchcast®, which is a knitted fiberglass fabric impregnated with a water-activated polyurethane resin that is curable. Exposure of the knitted fiberglass fabric to moisture or water initiates a chemical reaction which causes the fabric to become rigid. In its unhardened state, the water-activated polyurethane resin contains a very low volatility form of diisocyanate, commonly known as MDI. Once the knitted fiberglass product is cured, a rigid sleeve is created that is lightweight and strong. In one or more embodiments, after the lighting device is installed, the sleeve 34 may be wet with water and then will cure and harden in minutes, thus creating a rigid mounting of the track. Alternatively, the knitted fiberglass product can be immersed in water and immediately removed and wrapped around the mounting member to create a rigid sleeve. In other embodiments, the resin impregnated sleeve comprises materials other than a knitted fiberglass fabric. According to one or more embodiments, the sleeve 34 comprises a pliable material such as foam or cloth impregnated with a UV or visible light cured resin or a water-curable resin, or it comprises a thermoset plastic. In this way, application of light or heat then imparts rigidity to the sleeve In one or more embodiments, a two-part resin is used wherein a catalyst is sprayed onto the sleeved mounting members with a simple spray bottle and then hung, the resin curing within hours or overnight. In further embodiments, the sleeve comprises an impregnated foam, another form of cloth, and the like. In one or more embodiments, the sleeve 34 comprises a thermoset plastic, wherein the technician applies heat, via a heat gun for example, to cure and create a rigid sleeve.

A second aspect of the invention is directed to a method of installing a light device. According to one or more embodiments, the method comprises obtaining any lighting device disclosed herein, for example, a lighting device comprising a track and a light bar and/or a light source; associating and/or affixing one or more mounting members comprising a sleeve to the track and a mounting structure; and imparting rigidity to the sleeve. In one or more embodiments, the one or more mounting members comprise chain, wire cable, rope, or combinations thereof and the sleeve comprises a fiberglass mesh fabric, a foam, a cloth, or a thermoset plastic. The sleeve may be impregnated with a resin as needed to be effective to provide rigidity to the one or more mounting members. In a detailed embodiment, the fiberglass mesh fabric is impregnated with a water-activated resin, and the step to impart rigidity comprises exposing the sleeve to water. In one or more embodiments, the sleeve is effective to provide rigidity to the one or more mounting members.

A third aspect of the invention is directed to a kit for illuminating a vehicle. According to one or more embodiments, the kit comprises any lighting device disclosed herein, for example, a lighting device comprising a track, a light bar, and a releasable brake; at least one mounting member; and a sleeve for the mounting member. In one specific embodiment, the sleeve comprises a knitted fiberglass fabric impregnated with a water-activated polyurethane resin that is curable. In one or more embodiments, the mounting member is selected from chain, rope, wire cable, or combinations thereof. When a technician receives/obtains the kit, the technician uses the at least one mounting member to mount the track of the lighting device to a ceiling or mounting structure. As one example, the sleeve may comprise a knitted fiberglass fabric impregnated with a water-activated polyurethane resin that is wrapped around the length of the mounting member to create a sleeve. The technician then wets, through spraying for example, the sleeve with water, which activates the resin and causes it to harden and become rigid. The light bar and releasable brake may then be mounted to the rigidly suspended track, and the light bar can be moved freely about the track to illuminate a vehicle as needed.

In one or more embodiments, the mounting member is received/obtained with the sleeve in place on the mounting member. Thus, when a technician receives/obtains the kit, the technician uses the at least one mounting member and sleeve as-is right out of the kit. In other embodiments, the sleeve is provided apart or separate from the mounting member and it is wrapped as needed and desired by the end user around the mounting member. When the sleeve is the knitted fiberglass fabric impregnated with a water-activated polyurethane resin that is curable, for example, the technician then wets, through spraying for example, the sleeve with water, which activates the resin and causes it to harden and become rigid. It is understood that different sleeves may be activated in different ways to become rigid. The result is that the light bar and releasable brake are mounted to a rigidly suspended track, and the light bar may be moved freely about the track to illuminate a vehicle as needed without sway of the track.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A lighting device comprising:
a track;
a light bar comprising a plurality of light sources in movable contact with the track; and
a releasable brake in communication with both the track and the light bar, the releasable brake having a first position that locks the light bar in place and a second position that allows the light bar to move freely;
wherein upon installation, the track is suspended from a ceiling by a mounting member which is sheathed in a sleeve, the sleeve being adapted to impart rigidity to the mounting member.

2. (canceled)

3. The lighting device of claim 1, wherein the track is continuous.

4. The lighting device of claim 1, wherein the releasable brake is operatively connected to an end of the light bar and a mobile mechanism.

5. The lighting device of claim 4, wherein the releasable brake comprises a spring plunger.

6. The lighting device of claim 5, further comprising a pull cord attached to the spring plunger for engaging the releasable brake.

7. (canceled)

8. The lighting device of claim 1 further comprising a fastener located on one end of the light bar, wherein in a first position, the light bar is substantially parallel to the track and in a second position, the light bar is angled to the track.

9. The lighting device of claim 1, wherein one end of the light bar is attached to the track by a hinge.

10-14. (canceled)

15. The lighting device of claim 1, wherein the mounting member is chain, wire cable, rope, or combinations thereof.

16. The lighting device of claim 15, wherein the sleeve comprises a fiberglass mesh fabric, a foam, a cloth, or a thermoset plastic.

17. A method of installing a light device, the method comprising:
obtaining a lighting device comprising a track and a light bar and/or a light source;
associating and/or affixing one or more mounting members comprising a sleeve to the track and a mounting structure; and
imparting rigidity to the sleeve.

18. The method of claim 17, wherein the one or more mounting members comprise chain, wire cable, rope, or combinations thereof and the sleeve comprises a fiberglass mesh fabric, a foam, a cloth, or a thermoset plastic.

19. The method of claim 18, wherein the sleeve comprises the fiberglass mesh fabric, the foam, or the cloth which is impregnated with a resin that is water-curable, UV or visible light curable, or two-part.

20. The method of claim 18, wherein the sleeve comprising a fiberglass mesh fabric that is impregnated with a water-activated resin, and wherein the step to impart rigidity comprises exposing the sleeve to water.

21. The method of claim 18, wherein the sleeve comprises the thermoset plastic which becomes rigid upon application of heat.

22. A kit for illuminating a vehicle, the kit comprising:
a lighting device comprising a track, a light bar, and a releasable brake;
at least one mounting member; and
a sleeve for the mounting member, the sleeve being adapted to impart rigidity to the mounting member.
